(19) United States
(12) Patent Application Publication
(10) Pub. No.: US 2025/0023282 A1
(43) Pub. Date: Jan. 16, 2025

(54) CCONNECTOR SUBASSEMBLY FOR A CABLE WITH INSULATED ELECTRIC WIRES, COMPRISING A METAL BODY CONTAINING AN ELECTRICALLY INSULATING BLOCK AND CENTRAL CONTACTS EACH CONNECTED TO A CABLE WIRE

(71) Applicants: RAYDIALL, VOIRON (FR); YAZAKI EUROPE Ltd, ESSEX (GB)

(72) Inventors: Sébastien ANNEQUIN, NANTESSAINT-NICOLAS-DE-MACHERIN (FR); Denis GABET, COLOMBE (FR); Stanislav SRZIC, ZAGREB (HR); Ricardo NUNO SANTOS REIS, ARGONCILHE SANTA MARIA DA FEIRA (PT)

(21) Appl. No.: 18/734,687

(22) Filed: Jun. 5, 2024

(30) Foreign Application Priority Data
Jun. 6, 2023 (FR) 2305647

(51) Int. Cl. H01R 13/422; H01R 13/6581

(52) U.S. Cl. CPC H01R 13/422; H01R 13/6581; H01R 2201/26

(57) ABSTRACT

A connector subassembly with an electrically insulating block and an outer shielding body includes apertures that are superposed on one another and arranged relatively to make it possible to see from the outside not only whether a central contact has correctly reached the reference plugged-in position, but also its progress inside the block as it is being plugged in.

### RELATED APPLICATION

This application claims the benefit of priority from French Patent Application No. 23 05647, filed on Jun. 6, 2023, the entirety of which is incorporated by reference.

### TECHNICAL FIELD

The present invention relates to the field of data and/or electric transmission connectors.

The invention relates more specifically to a connector in which the central contacts are connected to, preferably crimped onto, the ends of electric cable wires.

The invention relates in particular to connectors for transmitting data using cables comprising one or more pairs of shielded or unshielded transmission wires.

The invention relates more generally to any type of connector for transmitting electric signals and/or data and/or radio-frequency (RF) signals.

A beneficial application is connectors for motor vehicles.

### PRIOR ART

In the field of connectors for transmitting electric signals and/or data and/or radio-frequency (RF) signals, connectors with an electrically insulating block in which central contacts are preassembled, each being crimped or intended to be crimped about a stripped end of an electric cable wire, are known.

During assembly of such connectors, it is important to ensure that each central contact is plugged, i.e. assembled, in a final reference position inside an outer body or housing of the connector.

Patent FR3074616B1 discloses a connector of this type with a preassembled subassembly, which is illustrated in FIG. 1.

The preassembled connector subassembly 1 is intended to be connected and assembled on a cable 2 with wires insulated from one another.

The subassembly 1 comprises a metal body 10 made by cutting and rolling, forming an electromagnetic shielding body.

This shielding body 10 contains an electrically insulating block 11 into which are inserted central contacts 12, 13 comprising end crimping portions 14, 15 that extend by projecting away towards the rear of the insulating block 11.

These end portions 14, 15 of the central contacts 12, 13 are crimped about stripped ends of wire conductors of an electric cable.

This crimping may take place before or after the central contacts 12, 13 are plugged into the insulating block 11 in a reference position that must be as precise as possible in relation to the subassembly comprising the shielding body and the insulator.

In certain applications, notably in motor vehicles, it is even necessary to be able to measure, notably using lasers or optical cameras, the position of the end of a central contact in relation to an electrically insulating block of the connector or in relation to a shielding body.

Furthermore, the front portion of the insulator may incorporate shapes used to guide and centre the matching male central contact during connection with a matching connector, in order to mechanically protect the petals formed at the free end of the female central contact. This frustoconical shape, which extends a through-hole and is usually referred to as a “closed entry” or a “lead-in chamfer”, only allows the matching male central contact to pass if it is in the correct radial position. This frustoconical shape may prevent the position of the female central contact from being checked, since the end of the latter is not visible from the front portion of the insulator. In this case, there are standard solutions for viewing the female central contact from the sides or top/bottom of the connector, through one or more windows.

U.S. Ser. No. 11/437,738B2 thus proposes a window for viewing the end of a central contact assembled in a body of the connector. The main drawback of the disclosed solution is that viewing can only occur if and only if the central contact has been correctly plugged in. It is therefore impossible to follow the path of the central contact as it is being plugged in. Therefore, an incorrect alignment and/or an unwanted deformation of a portion of the central contact as it is being plugged in, which may ultimately adversely affect operation of the connector, may pass undetected.

Furthermore, the proposed solution is implemented for a connector with a single central contact, and therefore cannot be transposed to a connector with two central contacts arranged side-by-side, as in the configuration in FIG. 1.

Finally, the measurement of the central contact is at the very least difficult to guarantee given the relative position of the central contact and the very small opening of the disclosed viewing window.

Furthermore, this solution does not enable the position of the central contact in relation to the front face of the insulator to be measured directly. This is because the insulator is not in the field of vision of the monitoring operative or of the measuring machine at the same time as the central contact when said central contact is visible in the viewing window.

There is therefore a need to further improve the connectors in order to check not only that the reference plugged-in position of a central contact is correct therein, but also the step of plugging therein before the central contact reaches said reference position, while enabling a measurement of the end of the central contact in the reference position thereof in relation to the electrically insulating block.

The invention aims to address all or part of this need.

### SUMMARY OF THE INVENTION

To achieve this, one subject of the invention, according to one of the aspects thereof, is a connector subassembly comprising:
at least one central contact intended to be connected, preferably crimped, to the end of a wire of an electric cable,
an electrically insulating block comprising at least one cavity in which the central contact is plugged in to a reference position and at least one viewing aperture opening from the cavity,
an electrically conductive body forming a shielding body, comprising a seat in which the electrically insulating block is held, the shielding body comprising at least one viewing aperture opening towards the outside,
   wherein the front portion of the insulating block projects longitudinally beyond the front portion of the shielding body and the viewing apertures of the insulating block and of the shielding body are dimensioned and arranged relative to one another to enable at least the free end of the central contact to be viewed from the outside as said central contact is being plugged in and before it reaches its reference position and, once it has reached its reference position, wherein the distance between the free end of the central contact and the front end of the front portion of the insulating block delimiting a plane of reference can be measured from the outside using optical means. “Reference position” here means the final expected position of the central contact in the electrically insulating block in which a matching central contact can be coupled.

Advantageously, the optical means are adapted to measure the distance perpendicular to the longitudinal axis of the subassembly. In other words, this distance is measured optically without using any additional means other than those required to take the measurement itself, such as one or more mirrors designed to view the free end of the central contact from the front face, where the design of the front insulator so permits.

The electrically conductive body is preferably a one-piece part.

Also preferably, the viewing aperture or apertures of the insulating block are not through-apertures.

The longitudinal projection of the front portion of the insulating block forms an additional space that can be used to give the plug hole of the matching central contact a frustoconical shape, as detailed below.

According to a second advantageous variant embodiment, the front portion of the insulating block projects radially beyond the inner wall of the shielding body defining the seat of the insulating block. A radial projection of the insulating block physically protects all flexible grounding lugs of the shielding body that could be affected by mishandling.

Advantageously, these two variants are combined: the projection of the front portion of the insulating block longitudinally beyond the front portion of the shielding body and radially beyond the inner wall of the shielding body optimizes impedance matching at the interface between the central contact and the shielding body.

According to another advantageous variant embodiment, the front portion of the insulating block comprises at least one through-hole facing the cavity and, extending the front of the hole, at least one portion of the frustoconical peripheral wall, said hole being designed to mechanically protect the free end of the central contact. This frustoconical portion enables a matching central contact, typically male, to be re-centred during insertion thereof in the electrically insulating block, before coupling with the typically female central contact, which is in the reference position thereof.

According to an advantageous embodiment, the free end of each central contact comprises longitudinal strips separated from one another in the form of petals, the viewing apertures of the insulating block and of the shielding body being dimensioned and arranged relative to one another to enable at least a part of at least one petal to be viewed from the outside.

According to this embodiment, the viewing apertures of the insulating block and of the shielding body are advantageously dimensioned and arranged relative to one another to enable a single petal to be viewed from the outside. The viewing zone from the outside is kept as small as possible, thereby minimizing electromagnetic leaks (EMI).

Also according to this embodiment, the viewing apertures of the insulating block and of the shielding body are dimensioned and arranged relative to one another to enable at least a part of the length of at least one petal in the reference position of the central contact to be viewed from the outside. This makes it possible to check that the central contact has not been deformed as it was being plugged in.

According to another advantageous variant embodiment, the shielding body comprises a radially flexible lug intended to form an electric grounding lug, partially delimiting the viewing aperture.

According to another advantageous embodiment, the subassembly comprises two central contacts of which the rear portion is intended to be crimped about the conductor of a stripped wire at the end thereof, the insulating block comprising two cavities parallel with one another, one of the two central contacts being plugged into each of said cavities, and a protuberance projecting longitudinally at the rear and designed to guide each of the two central contacts, each of which is crimped onto the conductor of a stripped wire, as they are being plugged in. The rear protuberance of the insulating block thus makes it easier to plug in the central contacts previously crimped individually to an electric wire.

The invention also relates to a connector comprising:
at least one subassembly as described above,
a housing in which the subassembly is seated and fastened.

The invention thus essentially consists of a connector subassembly with an electrically insulating block and an outer shielding body comprising apertures that are superposed on one another and arranged relatively to make it possible to see from the outside not only whether a central contact has correctly reached the reference plugged-in position, but also its progress inside the block as it is being plugged in.

Functional measurement using optical means from the outside of the distance in relation to the front end of the front portion of the insulating block delimiting a plane of reference guarantees electric performance, notably electrical continuity between the central contacts.

The invention has many advantages over prior-art connectors, including:
protection of the end of the petals of the female central contact provided by shapes, including the frustoconical shape of the “closed entry” insulator,
checking the correct assembly by viewing a central contact in the electrically insulating block from the outside, both as it is being plugged in and once it has reached its reference position,
ability to precisely measure the distance between the front wall of the insulating block and the end of the central contact in the reference position thereof, optimizing the positioning of the central contact in the insulator, and thereby optimizing the covering of the coupled central contacts,
physical protection of all flexible grounding lugs formed in the shielding body by the radially projecting front portion of the insulating block,
at least maintaining RF performance, notably the characteristic impedance and EMI leaks despite the presence of viewing apertures.

Other advantages and features of the invention will become more clearly apparent upon reading the detailed description of exemplary implementations of the invention, given by way of non-limiting illustration with reference to the following figures.

### BRIEF DESCRIPTION OF THE DRAWINGS

FIG. 1 is a perspective view of an example connector subassembly with central contacts to be crimped according to the prior art.

FIG. 2 is a perspective view of a connector subassembly with central contacts according to the invention in a preassembled configuration and connected to a cable.

FIG. 3 is a top view of a subassembly according to FIG. 2, the central contacts being viewed from the outside in a position during plugging.

FIGS. 4 and 4A are respectively a top view and a longitudinal cross-sectional view of a subassembly according to FIG. 2, the central contacts being viewed from the outside in the reference plugged-in position thereof.

FIG. 5 is a perspective view of a variant embodiment of an electrically insulating block of a connector subassembly according to the invention.

FIG. 6 is a partial perspective view of an electrically insulating block according to FIG. 5 showing the relative position of the electric wires of a cable on which the central contacts plugged into the electrically insulating block are crimped.

FIG. 7 is an exploded view of a connector subassembly according to the invention.

FIG. 8 is an exploded view of a connector according to the invention with a subassembly according to FIG. 7 and a connector housing in which the subassembly is seated and fastened.

### DETAILED DESCRIPTION

Throughout the present application, the terms “front” and “rear” should be understood with respect to the connection face of a connector subassembly according to the invention. Thus, the front portion of the electrically insulating block is the portion intended to be in contact with the portion of a matching connector and the front portion of a central contact is the portion intended to be coupled with a central contact of the matching connector.

For the sake of clarity, the same reference number has been used for the same element of a subassembly according to the prior art and of a subassembly according to the invention.

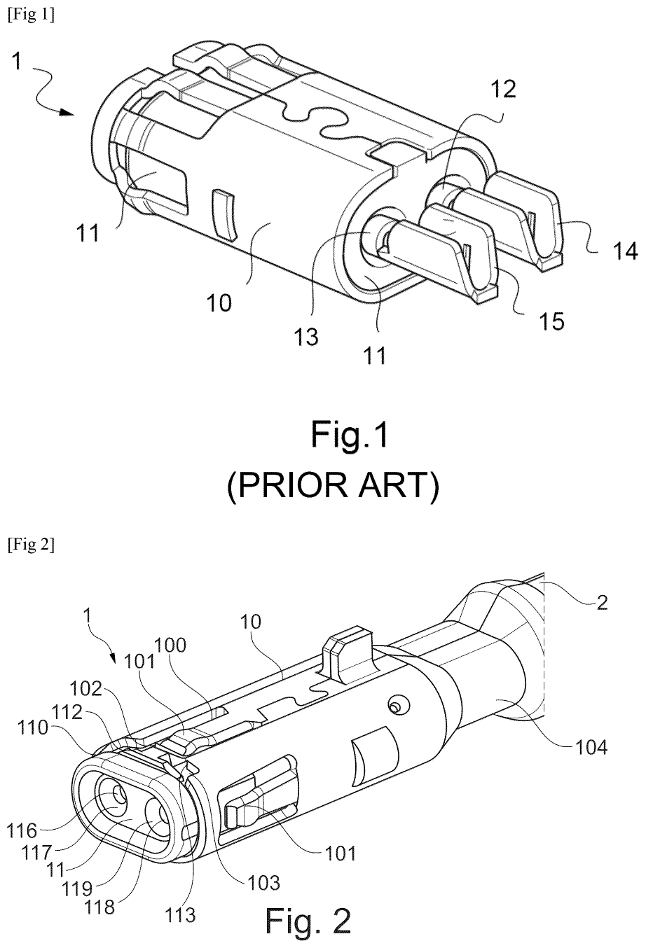

FIG. 1 has already been described in detail in the preamble. It will therefore not be commented on below.

FIGS. 2 to 4A show a connector subassembly 1 according to the invention in the assembled configuration thereof with the two central contacts thereof in the reference plugged-in position thereof.

The connector subassembly 1 extends along a longitudinal axis X, is preassembled, since it comprises an electrically insulating block 11 preassembled in a one-piece metal body 10 forming an electromagnetic shielding body. The subassembly 1 is connected and assembled on a cable 2 with wires insulated from one another.

The one-piece metal body 10 forming the electromagnetic shielding body is made by cutting and rolling, and guarantees electrical bonding and impedance matching.

Alternatively, this body may be formed of two longitudinal parts.

This shielding body 10 is delimited internally by a seat 100 in which the electrically insulating block 11 is held.

Central contacts 12, 13 comprising end crimping portions (not shown) that extend, notably by projecting away, towards the rear of the insulating block 11, are inserted into the electrically insulating block 11.

These end portions of the central contacts 12, 13 are crimped about stripped ends of wire conductors of the electric cable 2.

In the example illustrated, each central contact 12, 13 is female and comprises, at the front end thereof, material strips 120, 130 that are separated from one another to form petals.

The shielding body 10 comprises flexible lugs 101 forming electric grounding lugs that are distributed about the front periphery thereof, and there are four in the example illustrated.

A part of the front portion of the shielding body is cut out such that it opens forwards. This cutout defines, on both sides of the grounding lug 101 extending along one of the longitudinal edges of the body 10, a forward-opening aperture 102, 103 that forms an aperture for viewing a central contact 12 or 13.

The shielding body 10 further comprises a rear portion 104 that is narrowed. This narrowed portion 104 enables impedance matching between the rear portion of the subassembly 1 where the cable 2 is crimped, preferably beneath a shielding braid, and the front portion comprising the insulating block 11 into which the central contacts 12, 13 are plugged.

The insulating block 11 comprises a front portion 110 that projects both longitudinally beyond the front portion of the shielding body 10 and radially beyond the inner wall of the shielding body forming the seat 100. The front end of the front portion 110 of the insulating block 11 delimiting a plane of reference. Impedance matching at the interface between the subassembly 1 according to the invention and the matching subassembly coupled thereto is thus optimized. The radial projection of the front portion 110 mechanically protects the grounding lug 101 during coupling with the matching subassembly or during any other handling of the subassembly.

The insulating block 11 comprises, behind the front portion 110 and on both sides of a partition wall 111, a cutout 112, 113 extending a seating cavity 114, 115 for a central contact 12, 13. This cutout 112, 113 defines an aperture opening towards the outside of the insulating block 11 that forms an aperture for viewing a central contact 12 or 13. As illustrated, each of these apertures 112, 113 is not a through-aperture, but opens only on the side of the longitudinal edge of the block 11 that is overlapped by the edge of the shielding body 10 in which the viewing apertures 102, 103 are present. This helps to optimize impedance at the apertures 112, 113, retaining as much of the dielectric material of the insulating block 11 as possible, which is not replaced by air. The overlapping of the shielding body 10 above the cutouts 112, 113 limits EMI leaks.

Furthermore, the front portion 110 contains a through-hole 116, 118 facing each seating cavity 112, 113 for a central contact 12, 13. The peripheral wall 117, 119 extending the front of each hole 116, 118 is frustoconical. This frustoconical shape enables re-centring during insertion of a male central contact of a matching connector, in order to couple same with a central contact 12, 13 with petals 120, 130 in the reference plugged-in position thereof. The diameter of each hole 116, 118 is less than the external diameter of the front portion of the central contact 12, 13. This means that the male central contact of the matching connector is guided precisely in the diameter of this hole 116, 118, in order to aim at the space of the contact 12, 13 between the petals 120, 130 and to prevent any collisions with the front end of the petals 120, 130 and damage to said petals. In other words, the holes 116, 118 act as mechanical protections for the contacts 12, 13 during insertion and coupling of the matching male contacts.

The presence of each hole 116, 118, as well as the re-centring wall 117, 119, constitutes a protection function for the central contact 12, 13 referred to as “closed entry”.

The presence of each hole 116, 118 of limited diameter concealing the central contact 12, 13 from the front face of the subassembly means that it is no longer possible to check the presence of the central contact 12, 13 in the reference plugged-in position thereof.

To overcome this, cutouts 112, 113 are made in the insulating block and the cutouts 102, 103 are made in the shielding body to enable the presence of the central contact 12, 13 in the correct plugged-in position thereof to be checked.

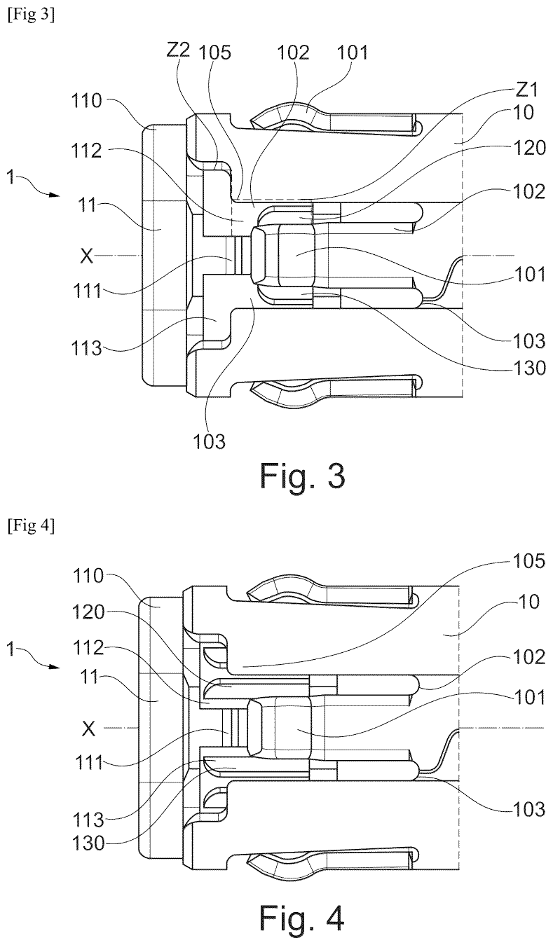

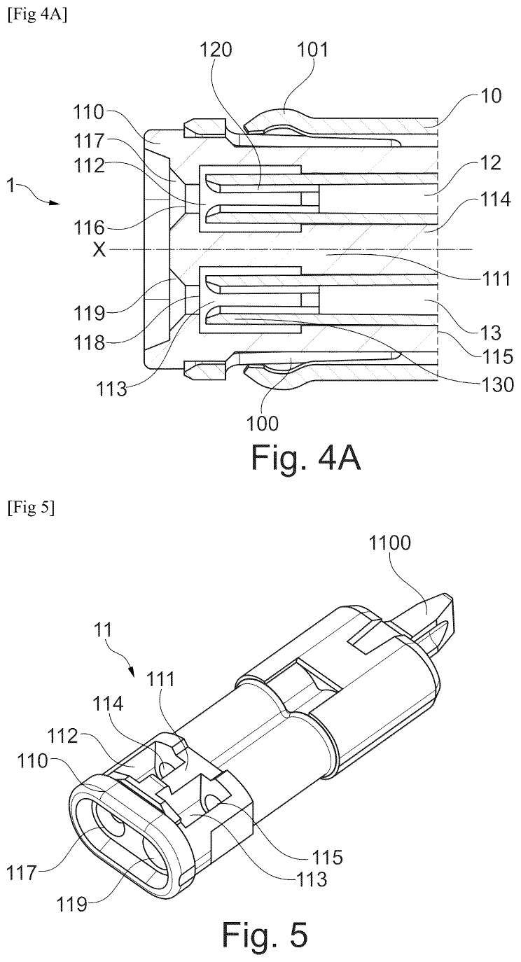

According to the invention, the viewing apertures 112, 113 of the insulating block and the viewing apertures 102, 103 of the shielding body 10 are dimensioned and arranged relative to one another to enable at least the free end of the central contact to be viewed from the outside as said central contact is being plugged in and before it reaches its reference position (FIG. 3) and, once it has reached its reference position (FIGS. 4, 4A).

In other words, the viewing apertures 102, 103, 112, 113 define two viewing zones Z1, Z2 that extend one another and respectively initially enable the progress of a central contact 12, 13 to be viewed as it is being plugged into the insulating block 11, and then enable said central contact to be viewed once it has reached its reference plugged-in position.

In the example illustrated in FIGS. 3 to 4A, the cutout 102, 103 of the shielding body is formed by a material recess 105 that enables the viewing aperture 102, 103 to be kept as small as possible, so that just one petal 120, 130 at least in the zone Z1 can be viewed. This minimizes EMI leaks by partially covering the cutout 112, 113 in the insulating block with a portion of the shielding body 10. Partially covering the cutout 112, 113 with a portion 110 of the shielding body also helps to locally optimize the impedance of the transmission line. The material recess 105 in the shielding body also widens the viewing zone Z2 to show the front end of the contact 12, 13 over the entire width of the contact. The zone Z2 enables a distance between the central contact end and for example the front end of the front portion of the insulating block to be measured.

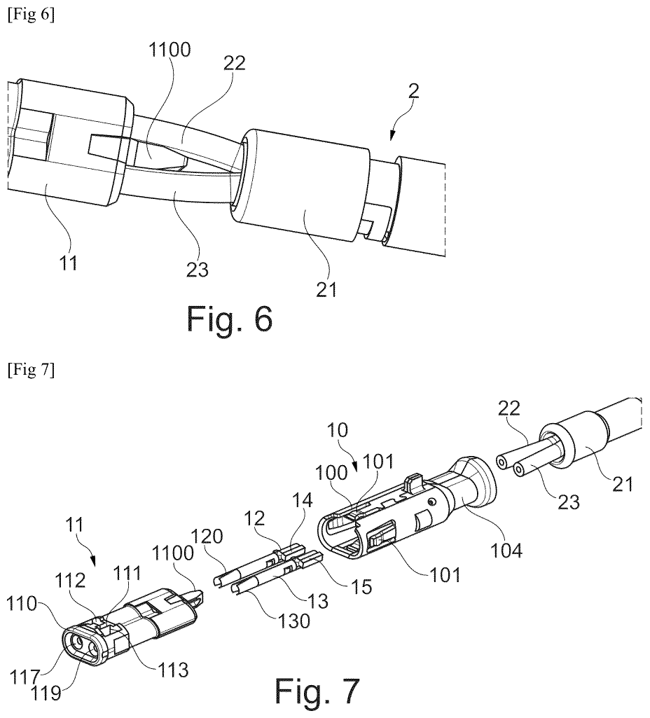

FIGS. 5 and 6 illustrate an advantageous variant in which a protuberance 1100 projecting longitudinally at the rear of the electrically insulating block 11. This protuberance 1100 is used to guide each of the two central contacts 12, 13, each of which is crimped onto the conductor of a stripped wire 22, 23 of a cable 2 with a sheath 21, as they are being plugged in.

The assembly method of the subassembly 1 described above comprises the following steps:
i) assembling the electrically insulating block 11, through the front of the shielding body 10, in the seat 100 thereof provided for this purpose in the shielding body 10,
ii) crimping the central contacts 12, 13 to the electric wires 22, 23 of an electric cable,
iii) plugging each wired central contact 12, 13 into the seating cavity 114, 115 thereof provided for this purpose in the insulating block 11, preferably with guidance from the protuberance 1100 at the rear of the insulating block 11,
iv) viewing each central contact 12, 13 in the zone Z1 as it is being plugged in,
v) viewing each central contact 12, 13 in the zone Z2 indicating that it has reached the reference plugged-in position thereof,
vi) visually measuring, from the outside, the position of the end of the central contact in relation to the front end of the insulating block 11 delimiting the plane of reference.

Step ii) may be carried out before step i).

FIG. 7 shows the components of the subassembly 1 according to the invention.

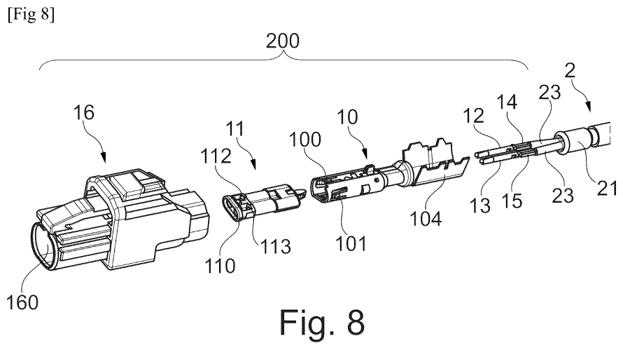

FIG. 8 shows a connector 200 with an adapted housing 16 in which a subassembly 1 like the one in FIG. 7 is seated and fastened, with each of the central contacts 12, 13 already crimped at the crimping portion 14, 15 thereof to the stripped end of one of the wires 22, 23 of the cable 2.

The housing 16 thus comprises an inner seat 160 shaped to receive the wired subassembly 1.

Other variants and improvements may be provided without thereby departing from the scope of the invention.

Although the connector subassembly in the examples illustrated is configured for two central contacts 12, 13 to be plugged into the seating cavities 114, 115 that are parallel to one another, the invention can also be implemented for a single central contact or for more than two central contacts to be plugged into a given electrically insulating block.

1. A connector subassembly comprising:
at least one central contact intended to be connected to the end of a wire of an electric cable,
an electrically insulating block comprising at least one cavity in which the central contact is plugged in to a reference position and at least one viewing aperture opening from the cavity,
an electrically conductive body forming a shielding body, comprising a seat in which the electrically insulating block is held, the shielding body comprising at least one viewing aperture opening towards the outside,
wherein the front portion of the insulating block projects longitudinally beyond the front portion of the shielding body and the viewing apertures of the insulating block and of the shielding body are dimensioned and arranged relative to one another to enable at least the free end of the central contact to be viewed from the outside as said central contact is being plugged in and before it reaches its reference position and, once it has reached its reference position, wherein the distance between the free end of the central contact and the front end of the front portion of the insulating block delimiting a plane of reference can be measured from the outside using optical means.

2. The connector subassembly according to claim 1, the optical means being adapted to measure the distance perpendicular to the longitudinal axis of the subassembly.

3. The connector subassembly according to claim 1, the electrically conductive body being a one-piece part.

4. The connector subassembly according to claim 1, the viewing aperture or apertures of the insulating block not being through-apertures.

5. The connector subassembly according to claim 1, the front portion of the insulating block projecting radially beyond the inner wall of the shielding body defining the seat of the insulating block.

6. The connector subassembly according to claim 1, the front portion of the insulating block comprising at least one through-hole facing the cavity and, extending the front of the hole, at least one portion of the frustoconical peripheral wall, said hole being designed to mechanically protect the free end of the central contact.

7. The connector subassembly according to claim 1, the free end of each central contact comprising longitudinal strips separated from one another in the form of petals, the viewing apertures of the insulating block and of the shielding body being dimensioned and arranged relative to one another to enable at least a part of at least one petal to be viewed from the outside.

8. The connector subassembly according to claim 4, the viewing apertures of the insulating block and of the shielding body being dimensioned and arranged relative to one another to enable a single petal to be viewed from the outside.

9. The connector subassembly according to claim 4, the viewing apertures of the insulating block and of the shielding body being dimensioned and arranged relative to one another to enable at least a part of the length of at least one petal in the reference position of the central contact to be viewed from the outside.

10. The connector subassembly according to claim 1, the shielding body comprising a radially flexible lug intended to form an electric grounding lug, partially delimiting the viewing aperture.

11. The connector subassembly according to claim 1, comprising two central contacts of which the rear portion is intended to be crimped about the conductor of a stripped wire at the end thereof, the insulating block comprising two cavities parallel with one another, one of the two central contacts being plugged into each of said cavities, and a protuberance projecting longitudinally at the rear and designed to guide each of the two central contacts, each of which is crimped onto the conductor of a stripped wire, as they are being plugged in.

12. A connector comprising:
a subassembly according to claim 1,
a housing in which the subassembly is seated and fastened.
